(19) United States
(12) Patent Application Publication
(10) Pub. No.: US 2006/0273907 A1
(43) Pub. Date: Dec. 7, 2006

(54) RFID-based system and toy

(76) Inventors: Morad Heiman, Rananna (IL); Elad Heiman, Rananna (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/143,057

(22) Filed: Jun. 1, 2005

(51) Int. Cl. G08B 13/14

(52) U.S. Cl. 340/572.2; 446/454

(57) ABSTRACT

A system that includes a toy that includes a RFID reader capable of interacting with RFID tags and a communication interface for exchanging signals with a computerized entity; and a computer readable medium having stored thereon a set of instructions, the set of instructions, when executed by a processor, cause the processor to interact with the toy. A system that includes a toy that includes a RFID reader capable of interacting with RFID tags and a communication interface for exchanging signals with a computerized entity; and a computerized entity adapted to interact with the toy.

### FIELD OF THE INVENTION

This invention relates to a RFID-based system and toy.

### BACKGROUND OF THE INVENTION

A RFID system usually includes an RFID reader and RFID tags. These elements can exchange information. RFID tags are very cheap and can be attached to objects for allowing object monitoring.

U.S. patent application 2004/0229696 of Beck, U.S. Pat. No. 6,761,637 of Weston et al and GB patent application GB 2381211 of Wilson et al, all being incorporated herein by reference, provide various illustrations of relatively limited uses of RFID technology in games and toys.

There is a growing need to provide an RFID based system that can allow a large variety of games and educational sessions.

### SUMMARY OF THE INVENTION

A system that includes: (i) a toy that includes an RFID reader capable of interacting with RFID tags and a communication interface for exchanging signals with a computerized entity; and (ii) a computer readable medium having stored thereon a set of instructions, the set of instructions, when executed by a processor, cause the processor to interact with the toy.

A system that includes: (i) a toy that includes a RFID reader capable of interacting with RFID tags and a communication interface for exchanging signals with a computerized entity; and (ii) a computerized entity adapted to interact with the toy.

A method that includes interacting with a computerized entity and interacting with RFID tags.

A method that includes interacting with RFID tags and associating time stamps to events. Whereas an event is generates as a response or reading a RFID tag or requires to read a RFID tag.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1 and 8 illustrate the electrical components of toys, according to various embodiments of the invention;

FIG. 2 illustrates a glove shaped toy and a doll shaped toy, according to various embodiments of the invention;

FIGS. 3 and 9 illustrate a RFID antenna array,according to an embodiment of the invention; and

FIGS. 4-7 illustrate systems according to various embodiments of the invention.

### DETAILED DESCRIPTION OF THE DRAWINGS

For convenience of explanation a person that uses the toy is referred to as a child. This is not necessarily so.

According to an embodiment of the invention the toy is connected by wireless connection or by wires to a computerized entity such as but not limited to a computer, a game console, a set top box, a DVD player, Mobile phone and the like. The wireless connection can be wireless connection such as but not limited to Bluetooth.

According to another embodiment of the invention the toy exchanges information with a wireless device (also termed wireless transceiver or wireless transmitter) such as a cellular phone. The cellular phone transmits the information over large ranges to another device. The wired connection can use a USB interface but this is not necessarily so and other interfaces can be used.

According to another embodiment of the invention the toy includes a timing module that can associate time stamps to events. This feature allows to use the toy in games or educational sessions that are time sensitive. For example, a child can be asked to virtually feed the toy at certain hours, virtually brush the toy's teeth before going to sleep, and the like.

According to an embodiment of the invention the toy can send the computerized entity information about the events that occurred. The computerized entity can evaluate these events and grade the performance of the child. This grade or rank can be responsive to a correlation between the generated events and expected events. The grade can be responsive to the timing of events. The grade calculation can be done by the toy and by the computer.

It is noted that an interactive game can have two parts. The first part includes a virtual game during which the computer is utilized while the other part does not include such a utilization. The first part can be viewed as a computerized game while the other one resembles “real world” games.

The first part of the game affects the second part of the game and vise versa. For example, playing with the toy generates a score and that score is used in the computerized game. Alternatively, the computer game can request the child to perform tasks in the “real world.

For example, a “boxing competition” game can include two parts. The toy is represented by a computerized boxer. The computerized boxer participates in a computer game. The characteristics of the boxer are affected from the treatment the toy receives from the child. The treatment quality can be determined in response to exercises, diet, medical treatment provided to the boxer.

According to various embodiments of the invention the toy can be used in different games. For example, the toy can be used in educational sessions, in games where the child takes care of the toy, in interactive games that require a computerized entity intervention, in multiple player games in which information about events generated by one toy are transmitted to other toys, and the like.

According to an embodiment of the invention the toy can interact with a computerized entity such as a DVD player in an open loop mode. In an open loop mode the toy be synchronized with a DVD player by requesting the child to initiate an event, by the DVD player (for example—displaying a request to press a certain button) and initiating the event.

According to another embodiment of the invention the toy can interact with a computerized entity such as a DVD player in a closed loop mode. In such as mode the toy exchanges control signals with the computerized entity. For example a child may be asked a question regarding the material played by the DVD player. The child answers by using the proper RFID tags or object that contains RFID tags The toy sends control signals to stop or replay a relevant part until the child provides the right answer. Alternatively, the response of the child can be used to select which scene to display.

According to an embodiment of the invention an antenna grid can determine a location of RFID tags placed in different locations and send information relating to the location of the tags and also to information stored in these tags (such as a tag ID) to the toy or to a mobile phone with RFID reader capabilities that can transmit the information to other toys or antenna grids. Conveniently the antenna grid also includes indicators that indicate the location of RFID tags that are located near (or on) another antenna grid. Real time transmission of information relating to RFID tags that are proximate to the RFID antenna can facilitate a multiple player game.

According to an embodiment of the invention a RFID antenna array is provided. The antennas are connected to the toy via a controllable switch that chooses which specific antenna to activate. For example, the child can be asked a question that is answered by placing a certain RFID associated object on a certain location. The switch can select the appropriate antenna of the array and the toy will determine if the right RFID associated object was placed on that antenna. It is noted that this is not necessarily so and the switch can selectively scan the whole antenna.

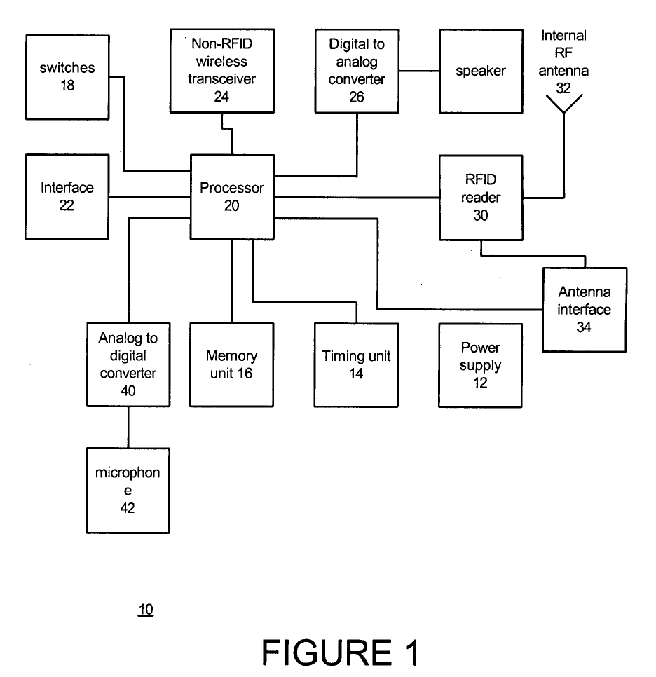

FIG. 1 illustrates the electrical components of a toy 10, according to an embodiment of the invention. The toy 10 includes a power supply 12, a timing unit 14, a memory unit 16, switches 18, a processor 20, an interface 22, a non-RFID short range wireless transceiver 24, a digital to analog converter 26, a speaker 28, a RFID reader 30, an internal antenna for RF signal of the RFID 32, an array antenna interface 34, a analog to digital converter 40 and a microphone 42.

It is noted that other configurations of toy 10 can be applied. Some of the illustrated components are optional, the toy can include additional components and the like. The connectivity between the components can vary. For example, although the digital to analog converter 26 and the analog to digital converter 40 are illustrated as connected to controller 20 they can be connected, alternatively or additionally, to the memory unit 16.

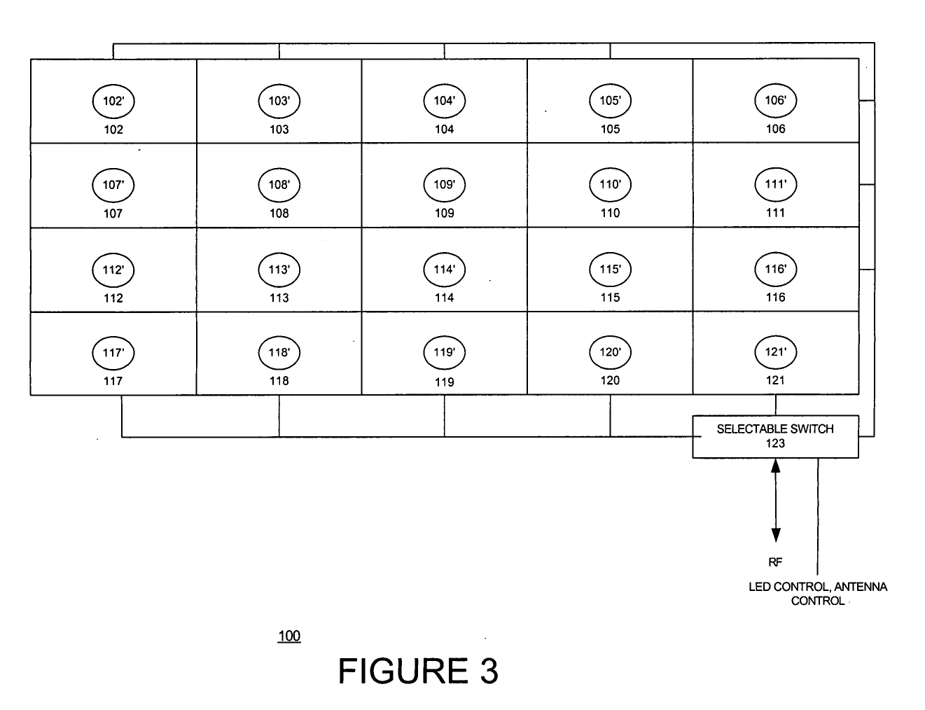

The processor 20 controls the various components. The processor 20 is adapted to: (i) read the status of switches 18, (ii) control speech or voice generation by the digital to analog converter and speaker 28, (iii) retrieve information of instruction from memory unit 16 as well as write information to the memory unit 16, (iv) exchange information with a computerized entity or another toy either via interface 22 or via transceiver 24, or via RFID communication channel(it is noted that the RFID reader can be activated in a way that two RFID reader can exchange information), (v) exchange information with RFID reader 30, (vi) to receive timing stamps from timing unit 14, (vii) to perform voice recognition in response to digital signals provided by analog to digital converter 40, and the like. The processor 20 can also control a controllable switch (illustrated in FIG. 3)) that is connected to a RFID antenna array

The switches 18 can be used to shut down or activate the toy, to determine various characteristics of a game (such as its difficulty level), or to receive input from a child. They can allow the child to input an answer to a previously asked question, allow the child to receive an audio indication of time and day, and the like.

Conveniently, RFID tags can be used as switches—once such a unique tag is detected by the toy the toy performs a selection that could be done by a switch.

The timing unit 14 is aimed to associate time stamps to events sensed by the toy 10 or events generated by the toy 10. It can include event generating dates such as weekends, birthdays, holidays and the like. Once such a date occurs the appropriate event is generated. It is noted that this event generation as well as the events themselves can be stored in the memory unit and can also require processor intervention.

The interface 22 can be also used for charging the power supply 12. The power supply can include batteries. The interface can be a USB interface and can optionally allow charging.

According to an embodiment of the invention the toy can be activated by detecting a special vocal command.

The toy 10 can receive from a computerized entity various signals representative of code or information or a combination of both. The computerized entity can update the code stored within the storage unit 16, retrieve data stored in the storage unit, and the like. The toy can receive information that allows it to perform speech synthesis and speech recognition. The vocabulary of synthesized/recognized words can vary from update to update and can be tailored to a specific game or educational session to be executed by toy 10.

Information that can be shared between the Toy and a computer can include, for example, a log file that is generated by the toy during the session that the child plays with the toy. This log file can be loaded to the computer for review the performance or progress of the child as well as to use this info to generate a score which can be compared to the score of the other players on the net.

The inventors use a Bluetooth compliant transceiver 24, but other transceivers can be used. The toy 10 can communicate with the computerized entity or another toy via wire (interface 22), by wireless (transceiver 24) or by a combination of both.

According to another embodiment of the invention the toy 10 can rewrite (reconfigure) RFID tags.

Conveniently, the timing unit 14 facilitates time based games, and can also allow to play with the toy only at predefined periods. The duration of these periods and the timing of these periods can be determined in advance, for example by the child's parents. Conveniently, the toy generate log file that records how long it takes the child to answer or to respond, when he responds, this info can be reviewed by the parents for evaluating the child progress.

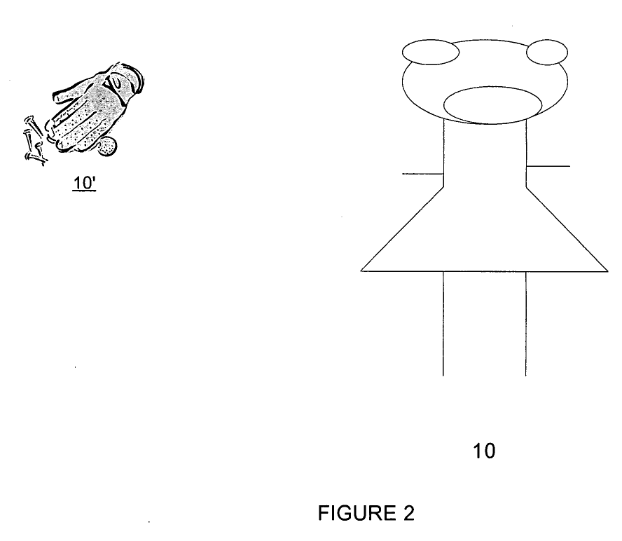

FIG. 2 illustrates a glove shaped toy 10′ and a doll shaped toy 10, according to various embodiments of the invention.

It is noted that the glove can be used as a multiple dimensional sensor that can perform various measurements relating to three dimensional objects, including their shape, weight and the like.

FIG. 3 illustrates a RFID antenna array 100, according to an embodiment of the invention. RFID antenna array 100 includes multiple antennas 102-121, that are connected to a switch 123 that performs time multiplexing schemes for selectively outputting the signals of a certain antenna to an output of the array 100.

Optionally, each antenna 102-121 includes an indicator (such as a LED) 102′-121′ that provides an indication about the location of an opponent objects. It is further noted that the indication can be provided by the computerized entity.

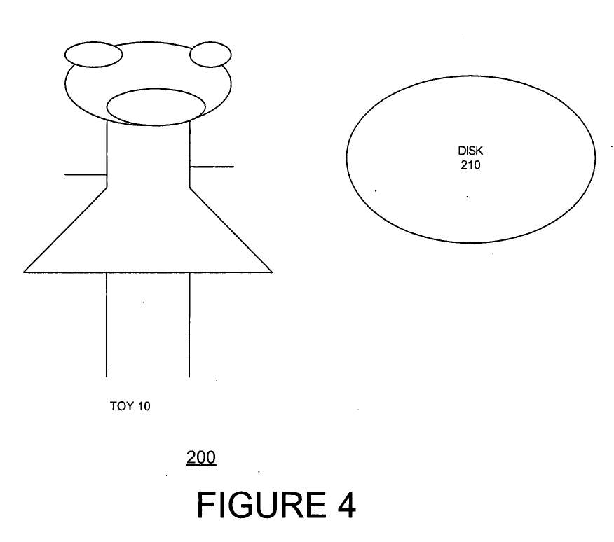

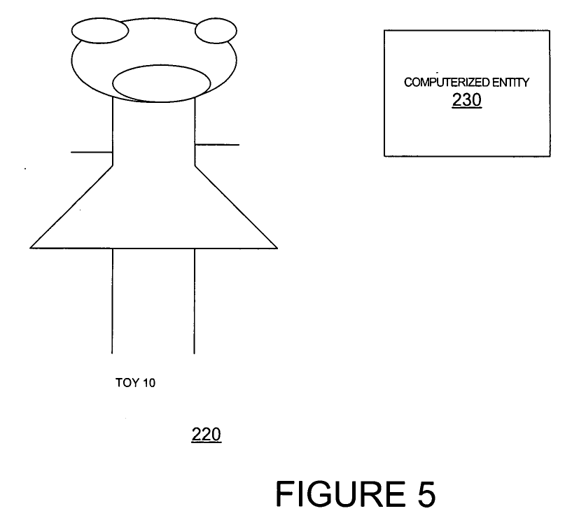

FIG. 4 illustrates a system 200 according to an embodiment of the invention. System 200 includes a toy, such as toy 10 that includes a RFID reader capable of interacting with RFID tags and a communication interface for exchanging signals with a computerized entity. System 200 also includes a computer readable medium (represented by disk 210) having stored thereon a set of instructions, the set of instructions, when executed by a processor, cause the processor to interact with the toy. FIG. 5 illustrates a system 220 according to an embodiment of the invention. System 220 includes a toy 10 such as toy 10 that includes a RFID reader capable of interacting with RFID tags and a communication interface for exchanging signals with a computerized entity. System 220 also includes a computerized entity 230 adapted to interact with the toy.

The computerized entity 230 has various components including a processor, storage units, communication cards and interfaces and the like. The processor executes a set of instructions that causes it to interact with toy 10.

The set of instructions can be stored in a computer readable medium such as but not limited to a magnetic medium, an optical medium, a magnetic medium and the like. Said medium can include removable medium (such as but not limited to disks, diskettes, compact disks, tapes, disks on key) and can include non-removable medium (such as but not limited to storage units, memory cards).

The medium can be accessed over various networks such as various LANs, WANs, the Internet and the like.

Conveniently, the toy includes a timing unit adapted to associate time stamps to events. Conveniently, system 220 includes a RFID antenna array adapted to transmit information representative of RFID tags located within the RFID antenna array reception area. Conveniently, the computerized entity 220 is adapted to evaluate events. The evaluation can be responsive to a timing of the events. Conveniently, the toy is adapted to control the computerized entity.

According to an embodiment of the invention such a system can facilitate hybrid games in which events that are generated or detected by the toy are a part of a computerized game that is being executed by the computerized entity. Additionally or alternatively, a child can gain virtual score or virtual money based upon his performance (in relation to the RFID toy). This money or score can be used in virtual games, to purchase items and the like. Additionally or alternatively, a child can gain virtual score or virtual money from RFID coupons that he may get via purchasing products that provides RFID coupon.

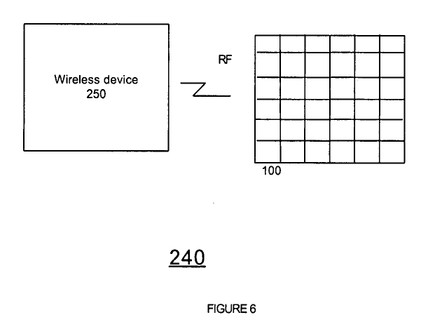

FIG. 6 illustrates a system 240 according to an embodiment of the invention. System 240 includes a wireless transceiver such as cellular phone 250 with RFID reader capabilities and a RFID antenna array 100 adapted to transmit information representative of RFID tags located within the RFID antenna array reception area.

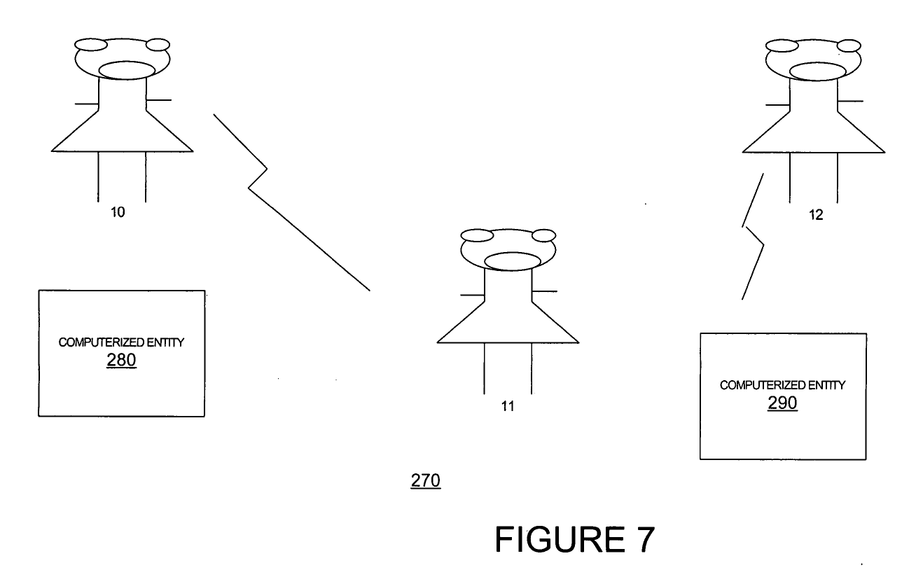

FIG. 7 illustrates a system 270 according to an embodiment of the invention. System 270 includes multiple toys 10, 11, 12 adapted to interact with each other; wherein each toy comprises a RFID reader and an interface for exchanging signals, directly or indirectly with another toy. Conveniently, one toy can exchange information with another toy using a wireless or a wired link. One toy can exchange information with another toy while using a single computerized entity such as computerized entity 280 as a relay. Conveniently, one toy can exchange information with a first computerized entity 280 that exchanges information with another computerized entity 290 that exchanges information with a second toy.

The mentioned above toys and/or systems enable to play various games. The following non-limiting examples illustrate some of the games that can be played with the toy.

An educational game during which RFID tags are associated to multiple objects and a child is requested to manipulate these objects, to evaluate a property of these objects (such as weight, size, color, shape, smell, and the like). A child can be requested to assemble a certain structure, building and the like from different objects. The toy or a computerized entity in communication with the toy can evaluate whether the assembling (or disassembling) succeeded by analyzing information retrieved from the RFID tags associated to the objects. In some cases the toy can be shaped as a glove to ease the assembling by the child.

A game in which the computerized entity displays images of objects that are associated with RFID tags, and request the child to perform various operations. toy acts as an input device.

A game in which the toy transmits in real time or near real time information it receives from the RFID tags and in response receives from the computerized entity instructions relating to the activation of the toy or a third object. The computerized entity can grade, evaluate the performance of the child, in response to the information provided from the toy. For example, a car that includes a reader can navigate between objects that are associated with RFID tags, and the computerized entity can instruct the child how to manipulate the car in response to the route of that car.

Yet a further game can involve the following stages: (i) producing audio-visual content and asking (either by the computerized entity or the toy) the child some questions. The questions that are generated by the toy can be synchronized with the displayed content in various manners including open loop synchronization (for example by asking the child to perform a certain operation when a certain content is displayed), closed loop synchronization and the like. In closed loop the presentation of various scenes can depend upon the reception of answers from the child.

A game that utilizes a RFID antenna array can include placing a matrix of pictures on the array and asking the child to place objects on certain locations. Another game that utilizes multiple RFID antenna arrays can include placing objects on a first RFID antenna array, transmitting to another player the location of these objects, receiving indication about the location of the objects of the second player and playing. Games such as checkers, chess, backgammon can use such a configuration. It is noted that the RFID antenna arrays can exchange information via a cellular phone, via computerized objects and via internet and the like.

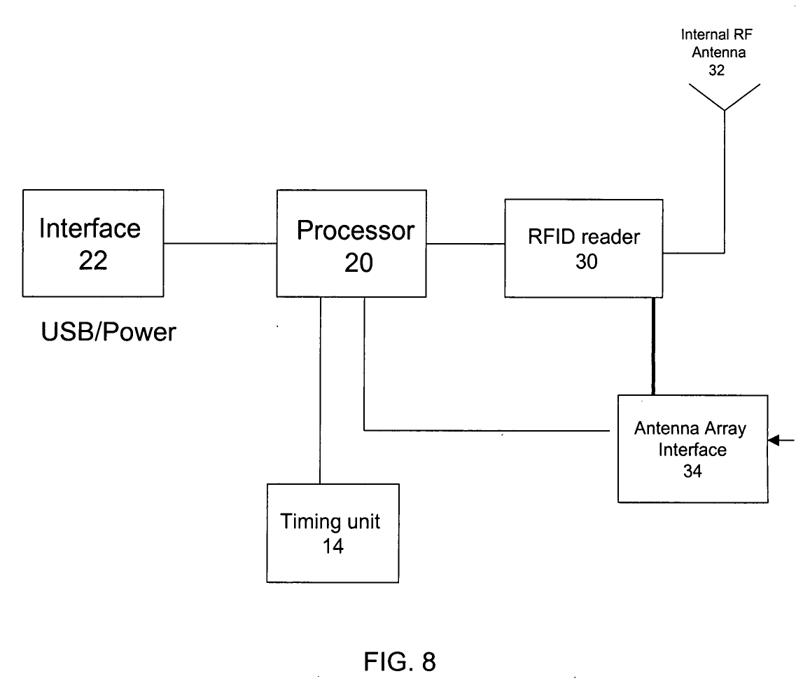

FIG. 8 illustrates a toy 10 according to an embodiment of the invention.

Toy 10 includes a processor 20 that is connected to an interface 22, an RFID reader 30, a timing unit 14 and an antenna array interface 34. The RFID reader 30 is also connected to an antenna 32 and to the antenna array interface 34.

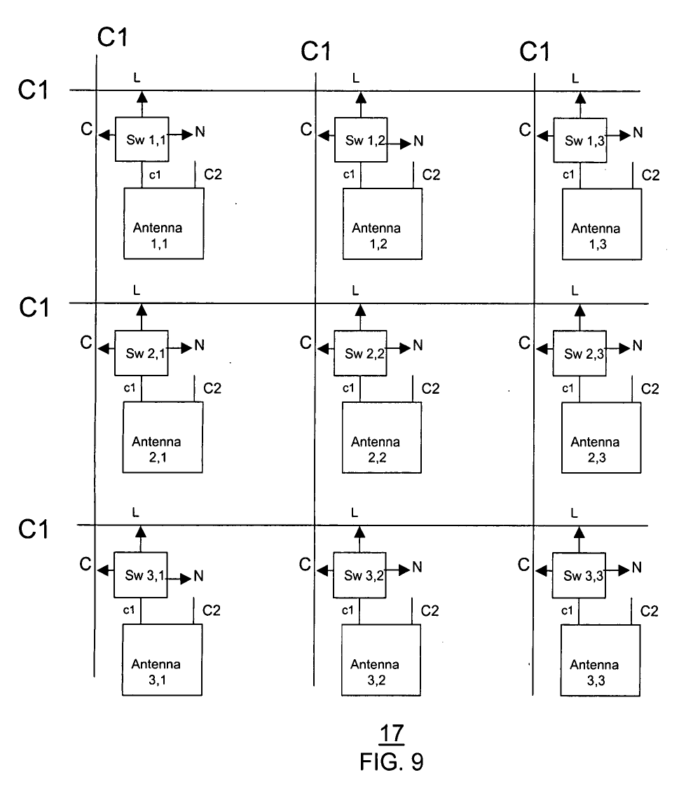

FIG. 9 illustrates an RFID antenna array 17, according to an embodiment of the invention.

The array include three columns and three rows. Each of the RFID antennas is connected via a multiple port switch to one line and one column. All the antennas are also connected to a common point denoted 34. A typical switch has a single input and three outputs. The input is connected to an output of a corresponding RFID antenna. A first output is connected to a line, the second input is connected to a column and the third output is not connected. By controlling the switches, the processor 20 can receive signals from the desired antenna.

The processor 20 can, for example, turn-on all the RFID antennas that are along a line, line by line and than column by column. The column number and the line number from which input signals were received are the (x,y) coordinates of the desired RFID tag. If there is more than one tag within the array, the computer will receive multiple (x,y) coordinates.

The connection of all the antennas along a line in order to become a line antenna and than by the appropriate switching of the antenna to configure it as a column antenna is facilitated by using switches.

If two tags are on the same line but in different column the interrogation process of RFID will check the corresponding columns in a serial manner such as to isolate the tags from each other.

According to an embodiment of the invention the RFID antenna array can be used as a three dimensional location sensing device. An array of RFID antennas can be located within an objects, such as a mattress or a carpet, and RFID tags are connected to of included within shoes, boots or otherwise located in proximity to a child's feet. The RFID antenna array can sense when the child is close to or on the carpet, and can perform these checks in various manners including periodical manner, semi-random manner, in response to contact between the child and the object, and the like.

A computer can illustrated a child (or other character) that jumps a rope and the “real” child has to jump whenever the virtual rope is close to the feet of the virtual child. Conveniently, the object can include display means, such as LEDs positioned in various locations of the object, that illustrated the position of another player. The other player has a similar object and both objects are connected to one or more computer for evaluating the input date from the RFID antenna array and for sending one player information about the other player.

According to an embodiment of the invention the RFID tags and RFID reader can detect the relative speed of a drive belt of a treadmill. The RFID reader is placed on a stationary portion of the treadmill, near the drive belt, while RFID tags are placed on the drive belt. The RFID reader can be connected to a computer that displays a virtualized character that also uses a treadmill, or runs in a virtual surroundings.

According to yet another embodiment of the invention an array of RFID tags are positioned in various locations within a boxing bag. The boxing glove includes an RFID reader. The strength and the location of the hit can be evaluated by the RFID tag (or RFID tags) that were received by the RFID reader. It is noted that according to another embodiment of the invention the boxing glove includes a tag and the boxing bag includes an array of RFID antenna. The strength of the hit can be evaluated by the RFID antenna (or antennas) that sensed the tag. In either case the strength of the hit can be evaluated by the computer that can use it within a virtual game such as a virtual boxing competition. The competition can be played by one or more children.

In general, the mentioned above games can be played by multiple players, whereas each player performs a physical movement or action that can be detected by the RFID antenna array and a RFID reader, that in turn sends inputs to a computer. The computer can evaluate these inputs and then use them within a virtual game. The virtual game can resemble the physical activities, but this is not necessarily so.

The present invention can be practiced by employing conventional tools, methodology and components. Accordingly, the details of such tools, component and methodology are not set forth herein in detail. In the previous descriptions, numerous specific details are set forth, such as shapes of test structures and materials that are electro-optically active, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

We claim:

1. A system comprising:
a toy that comprises a RFID reader capable of interacting with RFID tags and a communication interface for exchanging signals with a computerized entity; and
a computer readable medium having stored thereon a set of instructions, the set of instructions, when executed by a processor, cause the processor to interact with the toy.

2. The system according to claim 1 wherein the toy further comprises a timing unit adapted to associate time stamps to events.

3. The system according to claim 1 further comprising a RFID antenna array adapted to transmit information representative of RFID tags located within the RFID antenna array reception area.

4. The system according to claim 1 wherein the set of instructions cause the processor to evaluate events.

5. The system according to claim 1 wherein the evaluation is responsive to a timing of the events.

6. The system according to claim 1 wherein the toy is adapted to control the computerized entity.

7. The system according to claim 1 wherein the computerized entity is adapted to download information stored within the toy.

8. The system according to claim 1 adapted to update information or code stored within the toy.

9. A system comprising:
a toy that comprises a RFID reader capable of interacting with RFID tags and a communication interface for exchanging signals with a computerized entity; and
a computerized entity adapted to interact with the toy.

10. The system according to claim 9 wherein the toy further comprises a timing unit adapted to associate time stamps to events.

11. The system according to claim 9 further comprising a RFID antenna array adapted to transmit information representative of RFID tags located within the RFID antenna array reception area.

12. The system according to claim 9 wherein the computerized entity is adapted to evaluate events.

13. The system according to claim 9 wherein the evaluation is responsive to a timing of the events.

14. The system according to claim 9 wherein the toy is adapted to control the computerized entity.

15. The system according to claim 1 wherein a virtual game managed by the computer is responsive to input provided by the toy.

16. The system according to claim 1 adapted to facilitate a hybrid game.

17. The system according to claim 1 wherein the toy is adapted to generate or detect an event and the set of instructions cause a processor to respond to the detected or generated events.

18. The system according to claim 9 wherein a virtual game managed by the computer is responsive to input provided by the toy.

19. The system according to claim 1 wherein the toy is further adapted to perform a selection in response to information stored at a read RFID tag.

20. The system according to claim 1 wherein the toy is further adapted to receive vocal commands.

21. The system according to claim 1 wherein the toy is further adapted to provide a vocal response.

22. The system according to claim 1 wherein the toy is further adapted to write information to RFID tags.

23. The system according to claim 1 wherein the toy is further adapted to facilitate activation during predefined time periods.

24. The system according to claim 1 wherein the toy is further adapted to generate a log file.

25. The system according to claim 1 wherein the toy is further adapted to perform three dimensional measurements.

26. The system according to claim 1 wherein the toy is further adapted to control a computerized entity.

27. The system according to claim 1 wherein the toy is further adapted to be at least partially controlled by a remote controller.

28. The system according to claim 9 wherein the computerized entity is adapted to display images of objects that are associated with RFID tags.
